(19) United States
(12) Patent Application Publication
(10) Pub. No.: US 2004/0143659 A1
(43) Pub. Date: Jul. 22, 2004

(54) System and method for a scalable notification server providing

(76) Inventors: Russell C. Milliken, Pittsburgh, PA (US); Eswaran Subrahmanian, Pittsburgh, PA (US); Arthur W Westerberg, Pittsburgh, PA (US)

Correspondence Address: ECKERT SEAMANS CHERIN & MELLOTT, 600 GRANT STREET, 44TH FLOOR, PITTSBURGH, PA, 15219

(21) Appl. No.: 10/475,795

(22) PCT Filed: Apr. 26, 2002
(86) PCT No.: PCT/US02/12966

(51) Int. Cl. G06F 15/173

(52) U.S. Cl. 709/224; 709/226

(57) ABSTRACT

A method of servicing complex interests for a plurality of client applications or subscribers (8-10), includes specifying a plurality of complex interests from the applications or subscribers (8-10). At least one of the complex interests is formed from a plurality of constituent simple interests. A plurality of constraints are specified over the constituent simple interests. A plurality of event filters are specified from the applications or subscribers (8-10). A plurality of simple event filters (5), which match the constituent simple interests, are employed as at least one of the event filters. A set of events, which matches the at least one of the complex interests, is detected. One application or subscriber (8-10) is notified when the set of events is detected. At least one server (7) is employed to detect the set of events and notify the one application or subscriber (8-1) when the set of events is detected. The at least one server (7) is scaled.

### CROSS REFERENCE TO RELATED APPLICATION

This application claims the benefit of U.S. Provisional Application Serial No. 60/287,200, filed Apr. 27, 2001.

### BACKGROUND OF THE INVENTION

1. Field of the Invention

This invention relates to notification methods and systems and, more particularly, to methods and systems for providing notifications of simple and complex interests. The invention also relates to methods and apparatus for measuring performance of notification systems and, further, to such methods and apparatus for scaling performance of notification systems and, in particular, to a method for scaling a notification server.

2. Background Information

Frequently, a person, such as an employee, engaged in a collaborative endeavor will need to keep abreast of the actions of several co-workers at once. For example, only upon the completion of three asynchronous concurrent independent activities of three co-workers, should a fourth employee initiate a separate activity. Due to the sometimes emergent nature of collaborative work, employees cannot always determine these kinds of dependencies a priori. Even knowing the dependencies, keeping track of the status of several ongoing activities can be taxing. For example, what if one needs to keep track of five or more concurrent tasks? Even keeping track of two co-workers' tasks can be very wasteful of time if the status-checking process is an involved one. For these reasons, employees engaged in collaborative endeavors must be able to become aware of both single events and sets of events meeting specified criteria as they occur.

Allowing multiple software applications to interact has been a longstanding goal in the software industry.

The Object Management Group (OMG) is a not-for-profit industry consortium of over 800 companies committed to developing technically excellent, commercially viable and vendor independent specifications for the software industry. The OMG adopted the Common Object Request Broker Architecture (CORBA) specification as a standard in 1991. See The Common Object Request Broker: Architecture and Specification, formal/01-02-33, Object Management Group (2001). See, also, Mowbray, T. J., et al., The Essential CORBA: Systems Integration Using Distributed Objects, John Wiley & Sons, New York, N.Y. (1995).

By employing an implementation of the CORBA specification, a client application may easily make remote procedure calls to any other application that implements the CORBA specification (i.e., is “CORBA-compliant”). In turn, the CORBA-compliant application, which processed the procedure call, makes its external interface available with an implementation of an Object Request Broker (ORB). CORBA thus provides a mechanism for seamlessly integrating applications running on the same or different platforms.

As additional applications were interconnected or “wired together” with CORBA, it became necessary to be kept aware of events occurring in one application by another application, which was connected to the first. In order to make each one of n applications aware of events in the other n-1 applications, there have to be, in the worst case, n²interconnections between these applications. Thus, for n applications, the work involved in keeping each application aware of events occurring in all other applications is of the order of n². Furthermore, the notification process was not standardized across applications.

In response to the n² complexity problem, the OMG introduced and adopted the CORBA Event Services in 1993 and 1994. See Event Service Specification, formal/01-03-01, Object Management Group (2001). An implementation of the OMG Event Services specification (an “OMG Event Service”), which was compliant with the CORBA ORB specification, served as a central locale employed by applications to report the occurrence of unusual or extraordinary conditions and/or to receive notification of such events. The use of a central locale reduces the total number of interconnections from n² to n. Applications reported events to and/or received events from OMG Event Services. OMG Event Services distributed all reported events to all applications that wished to receive those events. The OMG Event Services specification modeled those events as unordered collections of named attribute/value pairs.

A client/server type system utilizing CORBA, as described above, is discussed in detail by Hirofuni Onodera in “CORBA: A Distributed Object Oriented Technology,” published by Soft Research Center, Apr. 25, 1996, pp. 182-85.

FIG. 1 shows a client 1 and server 2 system utilizing CORBA. With CORBA, an exchange of methods to and from an object existing somewhere on a distributed object is mediated by the ORB 3, which is one of the components comprising a distributed object environment. In other words, client 1 does not need to know whether server 2 is located on the same machine or on a network by virtue of the use of the ORB 3 and is able to transparently invoke a method contained in server 2.

Besides ORB 3, another component comprising the distributed object environment is a common object service. Among this service provided by CORBA, an CORBA Event Service implements asynchronous communications between the client 1 and the server 2. In an CORBA Event Service, a sender of events is referred to as “supplier” and a receiver of events is referred to as “consumer.” The asynchronous communications are implemented by the use of an object called “event channel.” The event channel allows a plurality of suppliers to communicate with a plurality of consumers asynchronously and without any knowledge of each other.

U.S. Pat. No. 6,148,339 discloses a health check system in a network control system utilizing a CORBA Event Service.

With the growth of the number of implementations of the CORBA Event Service specification, software applications that wished to receive events increasingly had to filter out the events of interest from all other events that were reported by the Event Services. Thus, in using an OMG Event Service, software developers traded the “not enough information” problem for a “too much information” problem.

In response to this problem, a content-based notification system, called Elvin, was developed and is loosely based on the OMG Event Services specification. See Distributed Systems Technology Centre, dCon User Guide, Distributed Systems Technology Centre, Queensland, Australia (1999); Segall, B., et al,. Elvin Has Left the Building: A Publish/Subscribe Notification Service with Quenching, Proceedings of the 1997 Australian UNIX and Open Systems User Group Conference, Brisbane, Australia (1997); and Fitzpatrick, G., et al., Instrumenting and Augmenting the Workaday World with a Generic Notification Service called Elvin, Proceedings of the Sixth European Conference on Computer Supported Cooperative Work, Copenhagen, Denmark (1999). Instead of delivering all reported events to clients as a CORBA Event Service would, Elvin provided the capability for applications to exactly specify the events of interest by employing event filters. Elvin passed on to the application only those events that are accepted by that application's event filters. These event filters are logical expressions written over the attributes of an event.

In 1999 and 2000, the OMG introduced and adopted the OMG Notification Services specification, with extensions to the CORBA Event Services specification, largely based on the experiments and experience with Elvin. See Object Management Group, CORBA services: Common Object Services Specification, Technical Report OMG formal/98-12-09, Object Management Group (1998); Object Management Group, Notification Services, Technical Report OMG telecom/99-07-01, Object Management Group (1999); and Notification Service Specification, formal/00-06-20, Object Management Group (2000). The OMG adopted Notification Services specification specifies a Notification Service that easily handles providing awareness of a single event. The OMG Notification Services specification also allows for an optional event-type repository which, if present, facilitates the formation of event filters by making readily available information about the structure of events which might flow through an OMG Event Service.

OMG Event and Notification Services are insufficient to deal with complex notification interests that involve multiple events across or within applications. Users of an OMG Notification Service desire to recognize plural sets of events that meet an arbitrary (e.g., complex; users can specify constraints across plural events matching plural interests) criteria When processing events reported to it, however, an OMG Notification Service makes no attempt to determine if there has been (or may be) any other past (or current) event(s) that may meet the criteria set forth in a subscribed application's event filter(s). The scope of the event filter is limited to the attributes of the event at hand.

In order to detect a set of interesting events, an application must register plural event filters and then locally (i.e., internally) evaluate the set of notifications received from an OMG Notification Service in order to determine if those notifications jointly represent an interesting event. This matching becomes exponentially more difficult as the number of sets of events that an application wishes to detect increases, and as the count of notifications received from an OMG Notification Service increases.

In addition, to ensure that applications detect all sets of events, each application must store events that belong in partially matched event filters for as long as the applications wish to detect those sets of events. Thus, a major disadvantage of this proposal is that all applications that wish to detect sets of events that meet arbitrary criteria become much more complex. Moreover, the complex code required to evaluate the received notifications is essentially duplicated in every application.

Di Nitto, et al., The JEDI Infrastructure and its Application to the Development of the OPSS WFMS, Proceedings of the Workshop on Internet-Scale Event Notification, Irvine, Calif. (1998), disclose JEDI, the Java Event-based Distributed Infrastructure, a content-based Notification Service with additional functionality. Subscribers may subscribe to receive single events meeting criteria or several events meeting independent criteria. JEDI allows applications to specify that they wish the content-based Notification Service to delay notification until JEDI detects a complete set of events meeting independent criteria.

Carzaniga, A, Architectures for an Event Notification Service Scalable to Wide-area Networks, Ph.D. Thesis, Politecnico di Milano, Milan, Italy (1998), discloses project Siena whose goal is the design and implementation of a scalable, general-purpose event service. Siena takes ideas from technologies such as the Usenet News infrastructure, IP multicasting, and the Domain Name Service to address the problem of Internet web server scalability while simultaneously providing a service that allows a precise filtration of events. Like JEDI, Siena allows logical relations to be written about independent event subscriptions. Siena also allows temporal relations to be written about subscriptions, that is, an application will only receive a notification if, for example, events match two independent subscriptions and do so in a certain temporal order. Carzaniga discloses an implementation of a prototype of Siena in Java.

JEDI and Siena provide specific, limited correlation of events.

There exists a need to provide users of a Notification Service with an arbitrary correlation of events in ways that the users find relevant.

U.S. Pat. No. 6,092,102 discloses the management of simple and compound events in the domain of clinical event monitoring. An expert system of an event monitor receives patient data from a database. In the most general terms, production systems, such as the expert system, are composed of “IF condition THEN action” rules, called productions and a working memory which contains information. Essentially, the production system operates by matching the contents of the working memory (e.g., patient data and information about drugs coming out of the database) against the “condition” of a production, and then executing the action. An event monitor looks for specific patterns in data, which define types of events, being passed to it from a data store, such as a data warehouse or database. Typically, if the event monitor finds a pattern in the data (i.e., an “event”), the event monitor evokes an inference engine, such as a rule-based expert system.

A clinical event monitor refers to an embedded expert system in the domain of clinical medicine. Clinical event monitoring may be classified as synchronous (e.g., the expert system runs in response to data entered by a clinician in real time, as in order entry) or asynchronous (e.g., all other circumstances, for example, when it is triggered by the arrival of laboratory results). A clinical event monitor evaluates events, in the context of information that may be known about a patient, and communicates conclusions via a communication channel to a user. The basic infrastructure needed to support event monitoring is a source of events, a source of patient data and a notification service. The event monitor itself is an algorithm that takes as input events, patient data and a representation of medical knowledge in various formats (e.g., rules), and outputs messages. See, for example, U.S. Pat. No. 6,092,102.

An event is data that triggers the execution of an event monitor. Events may be classified into four types: atomic, compound, atomic temporal and compound temporal. An atomic event is an event for which a specified piece of data creates an event. There is a 1-to-1 correspondence with external data. For example, in many systems the storage of a new laboratory result is an identifiable data event that corresponds to an event of interest to domain experts.

A compound event is defined by a static pattern in data. The data resulting in the static pattern that is matched can be generated from several events that modified the database. The compound event is equivalent to a query to the database to find matching data. Individual events are not kept track of in a persistent database. Thus, a compound event is a data pattern match in a database rather than the processing of the events themselves. For example, the event that an elderly patient is admitted to the hospital may be of interest to a domain expert, but it does not correspond to a single data event. The detection of compound events does not require that the event detector maintain a persistent store of its own.

An atomic temporal event is an atomic event, usually created by the event monitor itself, that causes an inference algorithm to run at some time in the future (e.g., an event monitor schedules a check for the existence of a gentamicin level 48 hours after the start of gentamicin). Thus, this is a future event set for checking data values at a specified future time. To implement atomic future events, an event monitor needs a persistent store to keep track of active events and clearing thereof.

A compound temporal event is a sequence of data (e.g., atomic, atomic temporal, compound) that, when recognized in a temporal order, causes the inference engine to run, which maps events of interests to users. Compound temporal events employ both persistent storage and algorithms that recognize temporal patterns. The typical locus for most temporal inference is within the expert system, not at the level of event, although there is a need to map from temporal patterns in the data to events of interest for knowledge users.

An example of a clinical event monitor is discussed in Hripcsak, G., et al., “Design of a Clinical Event Monitor,” Computers and Biomedical Research Vol. 29, pp. 194-221 (1996). As shown in FIG. 2 of the Hripcsak et al. article, Medical Logic Module (MLM) rules in the clinical event monitor are written in an Arden Syntax.

U.S. Pat. No. 5,555,191 discusses various prior art references regarding clinical event monitors, one of which employs the Arden Syntax MLMs. Whenever a medical event occurs, the MLMs that are pertinent to that event are triggered. The MLMs read data from the hospital database, test a set of criteria and, if those criteria are satisfied, perform some action such as sending a message via electronic-mail, storing a message in the patient database or triggering other MLMs.

It is known to employ the selective dissemination of information in which computer systems filter new information (e.g., by employing the Boolean combination of keywords, such as, “word1” AND “word2”) on behalf of users, and collect user relevance feedback to refine the filters.

It is also known to employ intelligent computer programs called agents, to filter information on behalf of users. For example, a user of the Internet may specify to such an agent the user's interest in new web pages concerning a specified topic. As new web pages concerning that topic become available on the Internet, the agent sends an e-mail message to the user to provide notification of the availability of the new web page.

Accordingly, there is room for improvement in methods and apparatus, which provide event notification services.

Notification services inform a client or person of the occurrence of events of interest within their office, work and personal information spaces. Such services are starting to become pervasive as part of many applications.

Generalized notification services are embedded as part of web based and other office/work based services. Current known measures to monitor the performance of these generalized notification services, in order to assure a basic quality of service, are inadequate measures of performance.

Scalability is the ability of a computer service to maintain a consistent level of performance while meeting an increasing load, or to deliver improved performance in response to increasing user need under the same load. For example, in order to determine the scalability of a server farm, one measures the load on the servers (e.g., the count of hits per second) and the servers' performance (e.g., the average time to respond to a hit) in response to an increasing load.

Regardless of the efficiencies of implementation (e.g., the computation power of the server platform; the bandwidth of the communication network to the clients), a notification service has a finite performance limit. The point that a notification service of particular implementation, configuration, and connectivity reaches its performance limit depends upon the number of simultaneous users of the service, user demands on the service, and user expectations for an acceptable speed of interaction.

Given the whimsical nature of users' consideration of their own needs, it may not be possible to predict with any certainty what performance is required of the notification service. Because of variations in users' needs for a notification service (i.e., real or perceived), the service's performance limit may be reached rather quickly and unexpectedly.

Prism Technologies discloses a performance evaluation of an OpenFusion implementation of the OMG Notification Service specification. See Prism Technologies, Open Fusion Notification Service Performance Evaluation. Prism Technologies (2000) (http://www.prismtechnologies.com/English/Products/openfusion/whitepapers/download_pdf/performance.pdf). This publication discloses an event throughput rate for delivering events to a single event consumer of as much as 436 events per second, with clients employing a Pentium III, 550 MHz personal computer (PC) having 256 Mb of RAM in Windows NT 4.0 (Service Pack 5), and with the OMG Notification Service running on a 450 MHz version of the same computer. Testing included “timing the delivery of 200 structured events to an event consumer” and increasing the OpenFusion program stack size from its default of 100 Mb to 200 Mb.

It is believed that the foregoing tests were run for as little as 0.459 seconds (i.e., 200 events at 436 events per second). Given the speed at which the tests were conducted and the large, nearly instantaneous memory requirements of OpenFusion, it is believed that the accuracy of the purported event throughput is cast into doubt. In this regard, it is believed that the tests measured an event report rate and assumed that OpenFusion delivered those events to consumers (i.e., assumed that the event report rate, and the event delivery rate were equal). In this manner, it is believed that because OpenFusion could not deliver events to consumers as fast as those events were reported to it, OpenFusion stored them in a cache (i.e., requiring more RAM) prior to delivery. It is further believed that there was a relatively large holdup of events in OpenFusion, in order to require a stack size increase of 100 Mb to 200 Mb.

A subsequent Prism Technologies publication discloses results from more carefully conducted performance studies that measure independent event report and delivery rates. This purports to show linear performance scalability with the count of users of Prism's OMG Notification Services implementation, OpenFusion. It is believed that the publication is silent regarding what one would do if performance drops below a tolerable threshold, and the need for equality of event receipt and event delivery rates at the server.

Accordingly, without a standardized method for measuring the performance of a notification service, software vendors can craft their own tests that may or may not measure what the user needs and, further, discount unexpected observances like the foregoing example as not having any effect on measured performance.

Ramduny, D., et al., Exploring the Design Space for Notification Servers, Proceedings of the 1998 ACM Conference on Computer Supported Cooperative Work, Seattle, Wash. (1998), define feedthrough as the ability of a user to see the effects of another's actions. Feedthrough is contrasted with feedback, which allows a user to see the effects of his or her own actions.

In assessing the performance of a database system, an observer determines how much time is required to execute several standard queries of varying complexity. In other words, the observer establishes benchmarks to which various queries are compared. See Dunham, J., Database Tuning Performance Handbook, McGraw Hill, New York, N.Y. (1997).

In querying a database for information, an observer knows the exact starting time of the query and the exact time that the results are received. The elapsed time depends upon, for example, the complexity of the query and the amount of information returned by the query. In assessing a notification service, an observer's measurements involve a more difficult process than measurements for a database system.

An observer may characterize the performance of a notification service in many ways. However, from the client's point of view, assessing the performance of the notification service is simple: either it provides appropriate feedthrough or it does not.

There is room for improvement in methods and apparatus for measuring performance of notification systems.

### SUMMARY OF THE INVENTION

A possible solution to the “too much information” problem and other problems is to augment the OMG Notification Services specification in order to allow applications to declare event filters that match sets of events. This approach, however, passes the code complexity from the applications that wish to detect sets of events to implementations of the OMG Notification Services specification. Because of this complexity increase, an OMG Notification Service with complex interest functionality would not scale as well in response to increases in load or more urgent demand(s) as an OMG Notification Service without this complexity. For this reason, a different solution is needed which provides the desired functionality, but without making applications that use a Notification Service more complex and without negatively impacting the performance of current implementations of the OMG Notification Services specification.

The present invention addresses the deficiencies of the prior art and provides a method and apparatus that allows a subscriber or client to express complex interests and notifies a subscriber or client when a set of events are detected that match the specified complex interest. This is provided through a Complex Interest Service (CIS). Preferably, with respect to an OMG compliant Notification Service, the CIS incorporates OMG compliant service and employs a scalable architecture (e.g., through the addition (or removal) of server instances) with respect to the performance of the OMG Notification Service and the CIS. Preferably, the apparatus is application-independent and may service any application attached to it. Preferably, the CIS services at least complex events, and may also service simple events.

The present method and apparatus provide a complex notification service that allows an application to specify a complex event filter in order to match a set of events, which meet an arbitrary set of criteria. When the complex notification service detects a set of events that satisfies all specified criteria, it notifies the interested client application in a manner similar to an OMG Notification Service, which notifies an application of an event passing through an event filter.

The complex notification service employs an OMG Notification Service in exactly the same manner as client applications currently use an OMG Notification Service for simple notifications. In this manner, applications that wish to detect sets of events that meet arbitrary criteria become subscribers of the Complex Interest Service application. The CIS, in turn, includes the services of an OMG Notification Service to provide its own service. An OMG Notification Service is well suited to provide this function.

As one aspect of the invention, a method of servicing complex interests for a plurality of client applications or subscribers, comprises: specifying a plurality of complex interests from the client applications or the subscribers; forming at least one of the complex interests from a plurality of constituent simple interests; specifying a plurality of constraints over the constituent simple interests; specifying a plurality of event filters from the client applications or the subscribers; employing as at least one of the event filters a plurality of simple event filters, which match the constituent simple interests; detecting a set of events, which set matches the at least one of the complex interests; notifying one of the client applications or the subscribers when the set of events is detected; employing at least one server to detect the set of events and to notify the one of the client applications or the subscribers when the set of events is detected; and scaling the at least one server.

The method may include mimicking a simple notification service to notify one of the client applications of an event passing through one of the event filters. A plurality of servers may be employed as the at least one server.

Preferably, a plurality of complex interest servers and at least one simple interest server are employed as the at least one server. The complex interest servers may be added or removed as a function of performance of the complex interest servers and the at least one simple interest server.

As another aspect of the invention, a scalable simple and complex interests notification system for a plurality of client applications or subscribers, comprises: means for specifying a plurality of complex interests from the client applications or the subscribers and forming at least one of the complex interests from a plurality of constituent simple interests, with a plurality of constraints specified over the constituent simple interests; means for receiving a plurality of event filters from the client applications or the subscribers; means for matching the constituent simple interests from a plurality of simple event filters; at least one server detecting the set of events, which set matches the at least one of the complex interests, and notifying the one of the client applications or the subscribers when the set of events is detected; and means for scaling the at least one server.

As another aspect of the invention, a method for providing a feedback measure for a server comprises: reporting an event from a client to the server; determining a first time at the client associated with reporting the event; receiving a callback at the client or an interested party from the server responsive to reporting the event; determining a second time at the client or at the interested party associated with receiving the callback; and employing a difference between the first and second times as the feedback measure.

A notification server may be employed as the server; and the feedback measure may be provided to the notification server. The feedback measure may be employed to evaluate time taken to service an interest by the notification server. The feedback measure may be employed to evaluate when to scale the notification server.

The method may include employing a scaling function in the server; inputting the feedback measure by the scaling function; and spawning another instance of the server if the feedback measure is greater than a threshold value.

As another aspect of the invention, a measuring notification client apparatus for providing a feedback measure for a notification server comprises: means for reporting an event at a first time to the server; means for determining the first time associated with the event; means for receiving a callback at a second time from the server responsive to the event; means for determining the second time associated with the callback; and means for determining a difference between the first and second times as the feedback measure.

As another aspect of the invention, a method for scaling a notification server comprises: employing a first notification server as the notification server; servicing a plurality of client applications and a plurality of interests at the first notification server; receiving a feedback measure associated with the first notification server; determining if the feedback measure is greater than a threshold value and responsively spawning a second notification server; and transferring some of the client applications and some of the interests from the first notification server to the second notification server.

The method may include employing a first feedback measure as the feedback measure associated with the first notification server; receiving a second feedback measure associated with the second notification server; and transferring the some of the client applications and the some of the interests from the first notification server to the second notification server until the first and second feedback measures are balanced.

The method may include spawning the second notification server from a third notification server. A first simple and complex interest server may be employed as the first notification server; and a second simple and complex interest server may be employed as the second notification server.

The method preferably includes employing at least one complex interest formed from a plurality of constituent simple interests for each of the client applications; counting the simple constituent interests for each of the client applications at the first notification server; and ordering the client applications based upon descending count of the simple constituent interests for each of the client applications.

The method may include spawning the second notification server and a third notification server from the first notification server; transferring a first set of the client applications and the interests from the first notification server to the second notification server; transferring a second different set of the client applications and the interests from the first notification server to the third notification server; and terminating the first notification server.

The method preferably includes counting partially matched complex interests for each of the client applications at the first notification server; and ordering the client applications based upon descending count of the partially matched complex interests for each of the client applications having identical counts of the simple constituent interests.

The method may include employing a simple interest server and a complex interest server as the first notification server; determining if the complex interest server is processor bound or memory bound; and for each of the client applications having identical counts of the simple constituent interests and identical counts of the partially matched complex interests, ordering the client applications based upon the client applications having most recently matched an incoming notification from the simple interest server if the complex interest server is processor bound and, alternatively, ordering the client applications based upon the client applications having least recently matched an incoming notification from the simple interest server if the complex interest server is memory bound.

### BRIEF DESCRIPTION OF THE DRAWINGS

A full understanding of the invention can be gained from the following description of the preferred embodiments when read in conjunction with the accompanying drawings in which:

FIG. 1 is a block diagram of a client and server system utilizing CORBA.

FIG. 2 shows a definition of a typical simple interest.

FIG. 3 shows a specification of a typical complex interest, which includes three exemplary simple interests.

FIGS. 4A and 4B are block diagrams of server systems in accordance with embodiments of the present invention.

FIGS. 5A and 5B are block diagrams showing scaling of the complex notification service of FIG. 4B in accordance with other embodiments of the invention.

FIG. 6 shows representations of notifications being reported in response to events reported, which match the simple interests of FIG. 3 to events.

FIG. 7 shows a representation of the rule generated in response to the declaration of complex interest of FIG. 3.

FIG. 8 is a block diagram of a client/server measurement and notification system in accordance with another embodiment of the invention.

FIG. 9 is a block diagram of another client/server measurement and notification system in accordance with another embodiment of the invention.

FIG. 10 is flowchart and block diagram employed by the measuring notification client of FIG. 9.

FIG. 11 is flowchart employed by the measuring notification client of FIG. 9.

FIG. 12 is a block diagram of a client/server measurement and notification system in accordance with another embodiment of the invention.

FIGS. 13A-13D are flowcharts showing the initialization of the client connections to the Complex Interest Server (CIS) of FIG. 4B, the registration of interests, the notification of events, and the deactivation of interests, respectively.

FIG. 14 is flowchart of a procedure including a scaling decision function, which spawns a new CIS in light of a measurement of the holdup measure of FIG. 12.

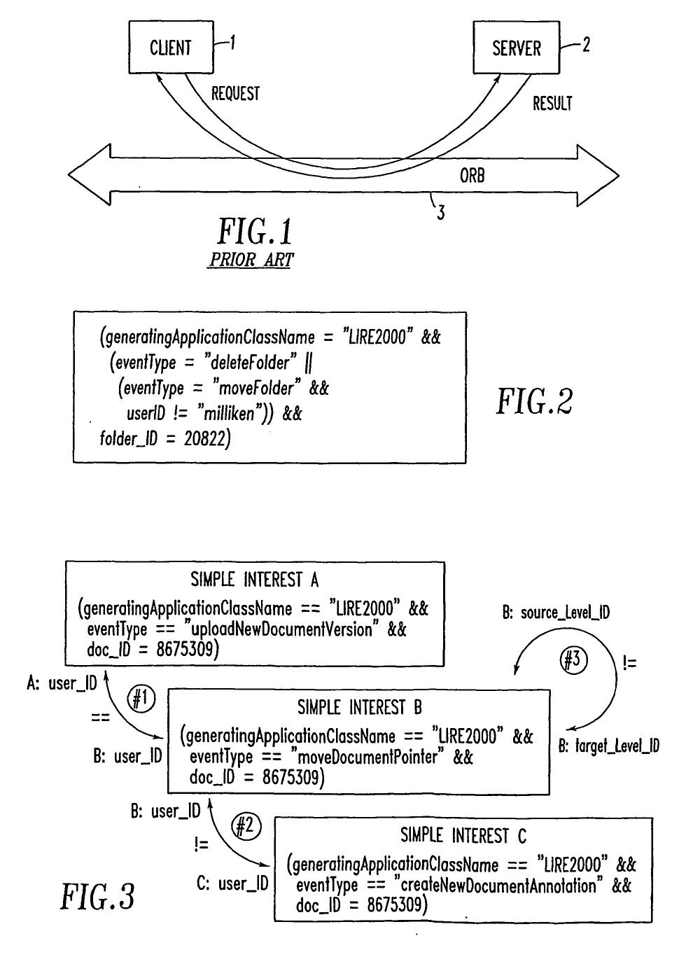

### DESCRIPTION OF THE PREFERRED EMBODIMENTS

As employed herein, the term “person” means a natural person, firm, corporation, other business or non-profit entity, association, group or organization.

As employed herein, the term “communication network” shall expressly include, but not be limited to, any local area network (LAN), wide area network (WAN), intranet, extranet, global communication network, wireless communication system or network, and the Internet.

As employed herein, the terms “display” and “displaying” shall expressly include, but not be limited to, computer displays for displaying notification information, such as, for example, interests, events and performance measures. It will be appreciated that such information may be stored, printed on hard copy, be computer modified, be combined with other data, or be transmitted for display elsewhere. All such processing shall be deemed to fall within the terms “display” or “displaying” as employed herein.

The use of the OMG Notification Service is discussed below in connection with a hypothetical document management system called DOC. The OMG Notification Services adopt an event-centric attribute/value model in order to allow reporting of all desired information about the occurrence of an event. OMG models events as unordered collections of uniquely named, mono-valued attributes. Event attributes may be one of any of the four basic data types: string, integer, float, or boolean. The Notification Services specification requires that event reporters supply at least the following attributes: domain_type (the domain of the application that reports the event) and type_name (the type of event being reported). The Notification Service supplies the event_name attribute (a unique name for this event). An example of a typical event's attribute/value pairs is shown in Table 1 (e.g., as reported by DOC; the event_name attribute is shown in Table 2).

TABLE 1

| Attribute Name | Attribute Value |
|---|---|
| domain_type | ICES DOC |
| type_name | DeleteFolder |
| Occurrence_date | Wed Feb 02 00:20:17 EST 2001 |
| parent_title | Document |
| folder_ID | 20822 |
| parent_ID | 20700 |
| user_ID | Milliken |
| folder_title | Old drafts |
| DOC_codebase | Version 0.9b |

OMG interests are C-language style boolean expressions that the Notification Service evaluates against the attributes of all reported events as they are reported to that Service. This evaluation process occurs exactly once for every reported event as long as the interest is active with the Service. Interests can be activated and de-activated at will by the client. When a client activates an interest with a Notification Service it receives a unique ID for that interest from the Service. Once activated, the client uses the unique ID for communications and for deactivation of that interest. When activated, a client simply refers to the interest's unique ID and tells the Service to deactivate it. Reactivation involves re-declaring the interest to the Service, which assigns it a new unique ID.

A well-written interest expression preferably always returns true when evaluated against events that the author deems interesting and false for all others. In this manner, the Notification Service does all the filtering of the event stream and delivers only relevant notifications to the client.

FIG. 2 shows a typical simple interest that matches the event shown previously. This interest is constructed to match when any of the applications whose class name is “DOC” reports a “deleteFolder” event type or a “moveFolder” event type not performed by “milliken” on a folder whose ID equals 20822.

Table 2 shows the attribute/value pairs of a generated notification that would be delivered to the interested party if the interest above is made active with the Notification Service and then DOC reports the above example event to the Service. The Notification Service adds the event_name attribute.

TABLE 2

| Attribute Name | Attribute Value |
|---|---|
| domain_type | ICES DOC |
| type_name | DeleteFolder |
| occurrence_date | Wed Feb 02 00:20:17 EST 2001 |
| parent_title | Document |
| folder_ID | 20822 |
| parent_ID | 20700 |
| user_ID | Milliken |
| folder_title | Old drafts |
| DOC_codebase | Version 0.9b |
| event_name | E200jRdubxwHB7K5a |

In the previous example, the simple interest matches a DOC “deleteFolder” event or a “moveFolder” event that is not performed by “milliken.” This logic to “weed out” uninteresting events operates over each event as it is reported. The OMG Notification Services make no attempt to determine if there has been (or may be) another event that may meet the criteria set forth in the interest expression. The scope of the simple interest is limited to the event at hand. Users of a Notification Service, however, require that they be able to recognize sets of events that meet arbitrary criteria, where “arbitrary criteria” are boolean logic expressions between and among the attributes of events in the set.

Users of a notification service should be allowed to define arbitrary inter-dependencies between events. For example, there may be three related events reported by DOC for which an application wishes to watch. The application wants the Service to notify it when someone uploads a new version of a specific document with ID 8675309 into DOC, the same person moves that document to a different folder in DOC, and someone else adds an annotation to that document.

As employed herein, a simple interest is the registration of interest on an action performed within a client application on the objects in the application. A simple interest can also be the registration of interest on an action performed on a class of objects within a client application. The client application registers this interest on behalf of a user of the application, or on its own behalf, to the notification service. The client application also knows what to do with the response from the notification service when an event generated by the application is recognized as being of interest. See, for example, FIG. 2.

As employed herein, complex interests are logical expressions (e.g., e1 and e2 or e3 or e4) over events that would match the constituent simple interests. This allows the specification of constraints across the attributes of events. See, for example, FIG. 3.

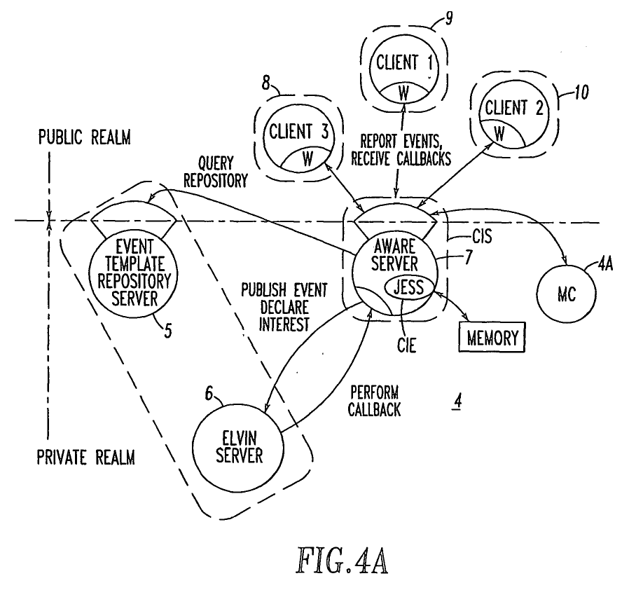

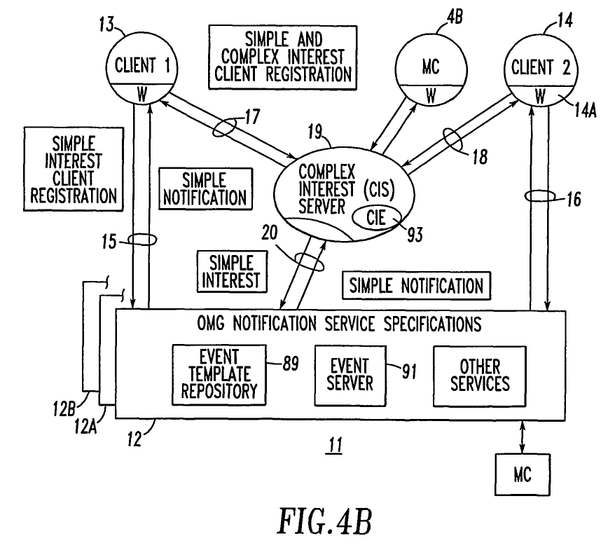

FIG. 4A shows an exemplary Complex Interest Server architecture 4, which includes a Measurement client (MC) 4A, an Event Template Repository server 5, an Elvin server 6, and a Complex Interest Server (CIS) 7. The exemplary servers 5,6,7 provide direct and indirect services to clients, such as 8,9,10. The CIS 7, as disclosed herein, incorporates features not present in the OMG Notification Server.

In the exemplary embodiment of FIG. 4A, complex interests are translated by the CIS application into simple interests for the Elvin server 6, and the events that match the simple interests are reported to the CIS 7. The CIS evaluates the complex interest constraints over the set of events that match the constituent simple interests using the Complex Interest Evaluator (CIE). When the CIE recognizes a match, the CIS notifies the client application when it satisfies the complex interest and recognizes a set of events that satisfy the constraints in the complex interest. The events of interest to the CIE are kept in a persistent store (e.g., working memory).

Incorporating temporality in interests is a specific instance of use of events' time attributes in the constraints.

FIG. 4B replaces the Event Template Repository 5 and the Elvin server 6 of FIG. 4A with an equivalent service provided by an OMG Notification Server 12 based upon the OMG Notification Service specification. There are three primary components of the generalized Complex Interest Server architecture 11 of FIG. 4B: (1) the Client interaction wrapper (W) 14A (e.g. of Client 14); (2) the Complex Interest Server (CIS) 19; and (3) the Measurement client (MC) 4B.

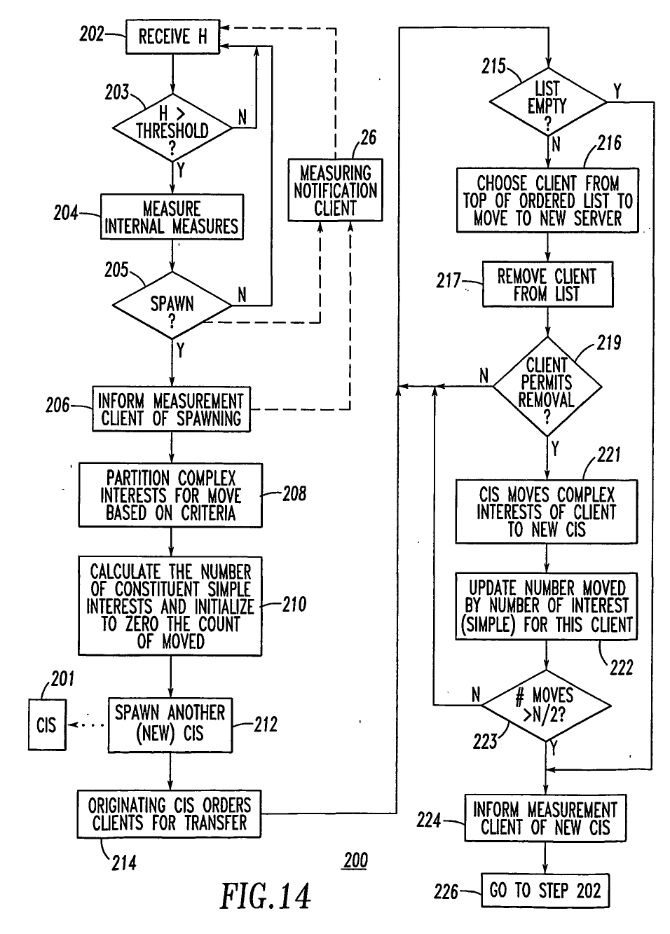

The Client wrapper (W) 14A includes two modules, the Communication module and the Administration module. The Communication module establishes communication between the application and the CIS 19, enables the registering of simple and complex interests with the CIS, and receives a notification from the CIS on the matching of a complex interest by the CIS. The Administrative module registers the event templates of the client with the Event Template Repository, receives a notification of a scaling operation (as discussed, below, in connection with the procedure 200 (including a scaling decision function) of FIG. 14) from the Communication module and, if necessary, changes its linkage to a newly spawned CIS instance 201 (FIG. 14) responsible for servicing the interests of this particular client (again, as discussed, below, in connection with FIG. 14).

The Complex Interest Server 19 receives a complex interest from a client and translates it into a collection of simple interests, each of which is registered with the OMG Notification Server 12 along with its constraint. These constraints are evaluated over the set of simple interests comprising the complex interest by the CIE (a rule-based pattern matching component) of the CIS 19. When the set of constraints is matched by the CIE, the CIS 19 notifies the client application wrapper 14A. The process of notification to the client for a complex interest is similar to the process of notifying the client of a simple interest. Any constraint on the temporal ordering of simple interests is a specific use of the time attribute of the simple interests. Registered clients and their complex interests are maintained in a client library within the CIS 19.

The Measurement client 4B is a specialized client of the CIS 19 whose role is to measure the performance of the CIS 19. The Measurement client 4B registers a special “Test” interest with the CIS 19 and the performance of the CIS 19 is computed by timing the receipt of the callback for this Test interest. The Measurement client 4B may be used with either the OMG Notification Server 12 or the CIS 19 for performance measurement.

The CIS 19 of FIG. 4B allows a client, such as 13,14, or the Measurement client 4B, to specify a set of simple interests and a set of constraints on the attributes of notifications that are returned from matching events to those interests. The CIS correlates notifications received that match the simple interests. When the CIS detects a set of notifications that satisfies all constraints specified, it notifies the client declaring the complex interest via callback in a similar manner as it notifies a client of the satisfaction of a simple interest.

Where simple interests can match a pattern among the attributes present on a single reported event (e.g., an atomic event; a simple interest), complex interests can recognize patterns among the attributes of several reported events. A complex interest's scope is the entire event stream taken the entire time that the interest is active with the CIS application. Like simple interests, complex interests can be activated and deactivated at will by the client.

FIG. 3 shows a specification of an exemplary complex interest that, when matched, satisfies the criteria for notification set forth in the above example. There are three exemplary simple interests corresponding to the upload, move, and annotation actions on document (ID) 8675309. In this example, there are three constraints that notifications that match these simple interests need to meet. First, the user ID of the notification returned by matching an event to simple interest A must be identical to the user ID of the notification returned by matching an event to simple interest B. Second, the user ID of the notification returned by matching an event to simple interest B must be unequal to the user ID of the notification returned by matching an event to simple interest C. Finally, the source level ID and target level ID of the notification returned by matching an event to simple interest B must be unequal. Once the CIS application finds a set of notifications that satisfies all the requirements placed on it by the client, it notifies the client as described above.

FIG. 4B shows the Measurement client 4B, which is similar to the Measurement client 4A of FIG. 4A. In the system 4 of FIG. 4A, all interests are routed through the CIS server 7. This, however, is not necessary and client applications, such as 13,14 of FIG. 4B, may handle registration and notification of respective simple interests 15,16 directly with the OMG Notification Server 12, while registration and notification of respective complex interests 17,18 are routed through the CIS 19 of FIG. 4B. The system of FIG. 4B also provides a variation of the embodiment of FIG. 4A where the single event interest registration by the client may be separated from the complex event interest by allowing the clients to choose the OMG Notification Server 12 independently of the CIS 19.

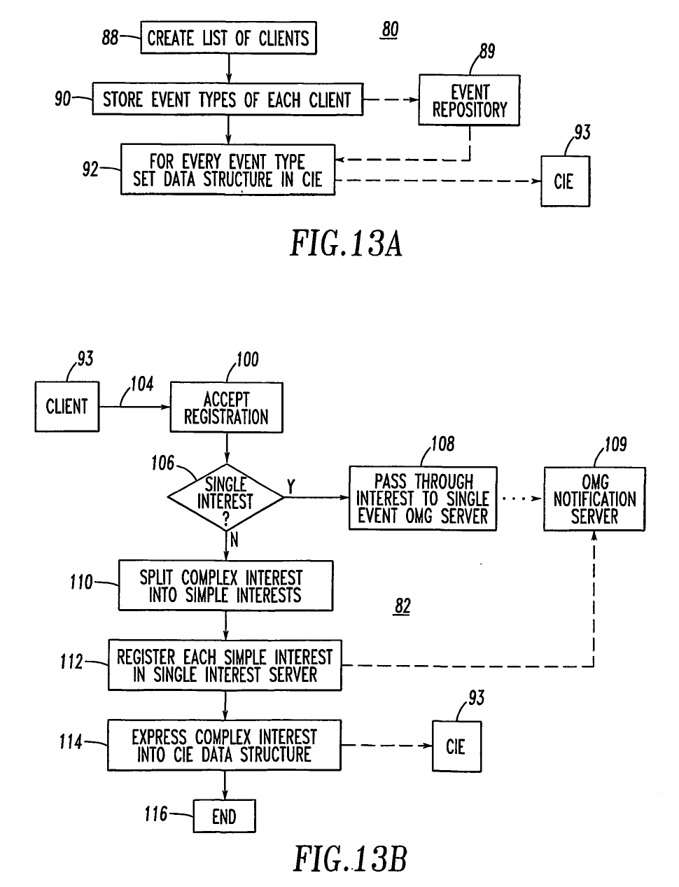

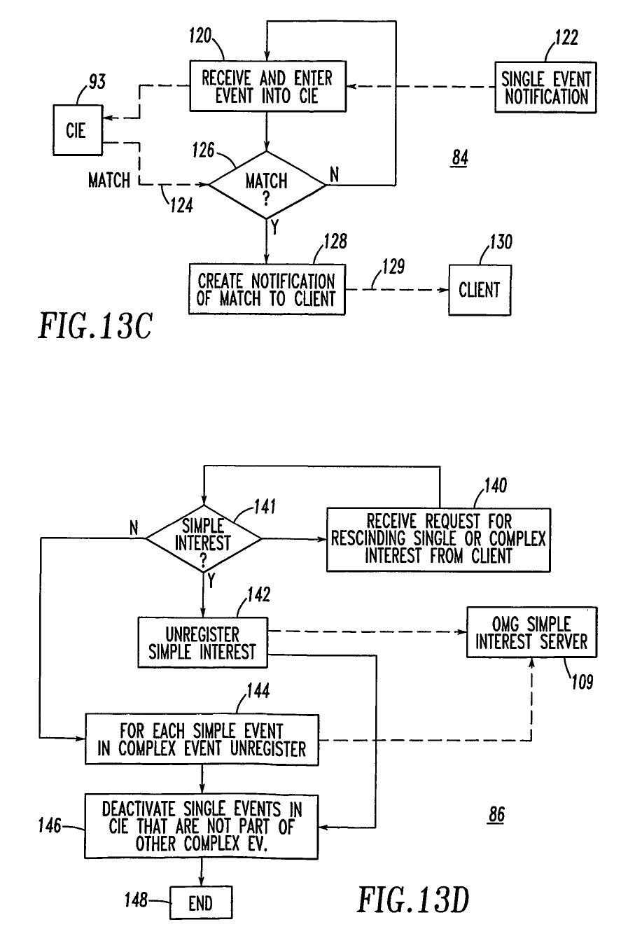

FIGS. 13A, 13B, 13C and 13D show the underlying procedures 80, 82, 84, and 86 for the initialization of the client connections to the CIS 19 of FIG. 4B, the registration of interests, the notification of events, and the deactivation of interests, respectively. As shown in FIG. 13A, the initialization procedure 80 for the CIS 19 includes: (1) creating a list of clients, at 88; (2) storing the event types of each client on the Event Template Repository 89, at 90; and (3) at 92, for every event template type in the Event Template Repository 89 for the client, setting up a data structure for storage of events corresponding to the event template in the CIE 93 to create a store of events as they occur based on callback from the OMG Notification Server 12.

The registration procedure 82 of FIG. 13B begins by accepting a registration, at 100, from a client 102 of an interest 104 (e.g., a single event (simple) interest; a complex event interest) at the CIS 19 of FIG. 4B. Next, at 106, it is determined if the interest is a simple interest. If so, then the interest is passed through, at 108, to the OMG (simple interest) Notification Server 109, which Server sets up to receive notification for pass through to the client 102. On the other hand, if there was a complex interest, at 106, then the complex interest is split into its constituent simple interests at 110. Then, at 112, each simple interest is registered with the OMG (simple interest) Notification Server 109, which Server sets up to receive notification for pass through to the client 102. Next, at 114, the complex interest is expressed as logical expressions over simple interest events using the single event storage structures in the complex interest evaluator CIE 93. Finally, the routine 82 ends at 116.

As shown in FIG. 13C, the notification procedure 84 begins, at 120, by receiving the simple interest event notifications 122 that are part of the complex event interests. These events are entered using the storage structure for the event in the CIE 93, which reports matches 124. Next, at 126, if a match is reported by the CIE 93 for a complex event interest, then, at 128, a notification 129 is created for a client 130, which registered the complex event interest. Otherwise, if there was no match at 126, then step 120 is repeated.

The deactivation procedure 86 of FIG. 13D begins, at 140, by receiving a request to rescind a simple interest or a complex interest from a client. At 141, it is determined if the request is for a simple interest. If so, then at 142, the simple interest is un-registered from the OMG Notification Server 109, after which the procedure 86 ends at 148.

On the other hand, if a request is received from a client to rescind a complex interest at 141, then, at 144, for each simple interest in the complex interest, that simple interest is un-registered from the simple interest OMG Notification Server 109. Next, at 146, for each simple interest that participates in the deactivated complex interest and does not participate in any other registered complex interest, all the record of events in the CIE 93 (FIGS. 13B and 13C) are de-activated which are associated with the simple interest that is part of the deactivated complex interest. Finally, the procedure 86 ends at 148.

The procedures 80,82,84,86 of FIGS. 13A-13D describe the operation of the Complex Interest Server 19 in the absence of the scaling function.

The exemplary notification service measurement clients 4A and 4B of FIGS. 4A and 4B, respectively, evaluate the performance of the Complex Interest Servers 7 and 19. The Complex Interest Servers 7,19 are an extension to the generalized OMG Notification Server 12. These systems may be used in conjunction with a single client application or a collection of client applications across whose events the user can create either simple or complex interests. Clients using these Servers 7,19 may report the occurrence of events, declare and rescind simple or complex interests in the occurrence of interesting events, and add or remove callback addresses for interests.

As previously described, the Complex Interest Servers 7,19 provide the complex interest service by allowing clients to declare several simple interests and constraints evaluated against the notifications returned by events matching those interests. The Complex Interest Servers 7,19 declare the simple interests that constitute the complex interest and start receiving notifications of events that match these interests as they occur.

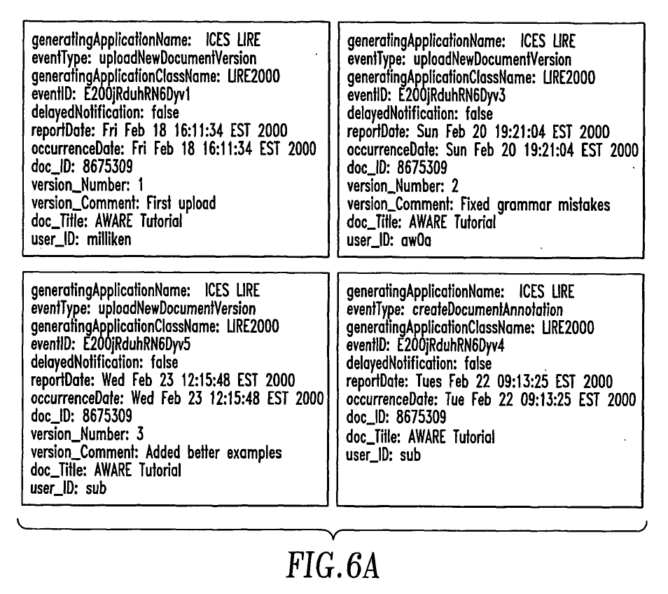

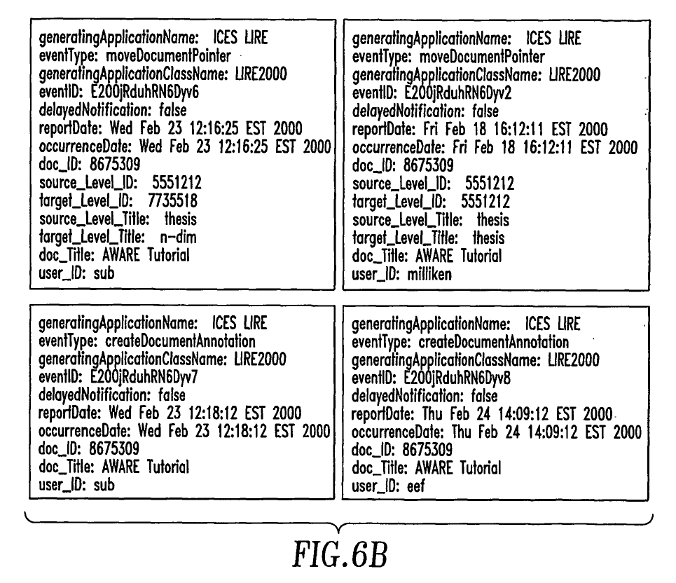

The Complex Interest Servers 7,19 check each arriving notification from the OMG Notification Server 12 to see if it satisfies all of the constraints that constitute the complex interest. The Complex Interest Servers 7,19 perform this check in the context of all other reported notifications. That is, a newly received notification is checked against all constraints on all complex interests and, for each constraint, all received notifications using the CIE 93. FIG. 6 shows several exemplary notifications that might be reported in response to reported events that match simple interests A, B, and C of FIG. 3 to events. As each notification is reported, the Complex Interest Servers 7,19 evaluate constraints #1, #2, and #3 in the example of FIG. 3 against all other received notifications using the CIE 93. There is exactly one set of notifications in this set of all notifications that match the complex interest shown above.

As the number of notifications reported for the constituent simple interests grows, it becomes more computationally costly for the CIE 93 to determine if all constraints are satisfied. Naively, this process takes the order of mnⁿ time for m constraints (e.g., simple and complex constraints) and n received notifications (i.e. received by one or more applications from the OMG Notification Server 12 of FIG. 4B). This is because every event notification has to be checked against n other notifications and hence n² times for all notifications (n) and doing this check over nm constraints leads to the mn² order of computation for the CIE. Clearly, this process does not scale well to a large number of notifications or, to a lesser degree, a large number of constraints. Hence, a less computationally intensive algorithm is desired.

The exemplary Complex Interest Servers 7,19 employ an expert system shell for the CIE 93 to evaluate the constraints of a complex interest against all the received notifications returned by events that match the constituent simple interests. An expert system is a program that models human expertise or knowledge in a well-defined problem domain. A tool called JESS, the Java Expert System Shell, is preferably employed to implement the expert system. JESS was originally inspired by the C-Language Integrated Production System (CLIPS) expert system shell, but has grown into a complete, distinct, Java-influenced environment of its own. CLIPS is an expert system provided by NASA since 1985. See Giarratano, J., CLIPS User's Guide, NASA, Lyndon B. Johnson Space Center, Information Systems Directorate, Software Technology Branch, Houston, Tex., jsc-25013 edition (1993).

Like CLIPS, JESS uses rule-based programming for expert system development. In this programming paradigm, rules are used to represent heuristics, or “rules of thumb,” that specify a set of actions to be performed for a given situation. A rule is composed of an if portion and a then portion. The if portion of a rule is a group of patterns that specify the data (or facts) that cause the rule to be applicable. JESS provides a mechanism, the inference engine, that automatically matches facts against patterns and determines which rules have all their patterns matched. Once JESS matches all of a rule's patterns, it is said to be active. Then, JESS moves it to the active set. The inference engine selects a rule from the active set, subject to a conflict resolution strategy should the active set contain two or more rules, and executes the actions in the then part of the selected rule. For example, some common conflict resolution strategies include: most recently activated rule first, oldest activated rule first, and most complex rule first. This may affect the list of active rules by adding or removing facts from working memory. The inference engine recomputes the active set, selects another rule, and executes its actions. This process continues until no applicable rules remain.

The if portion of a rule can be thought of as the whenever portion of a rule, since pattern matching always occurs whenever changes are made to facts, new facts are introduced, or currently asserted facts are retracted. The actions of activated rules are executed when JESS instructs the inference engine to begin execution.

The JESS language is very similar to the language defined by the CLIPS expert system shell, which, in turn, is a highly specialized form of the LISP programming language. For each notification from a constituent simple interest received, the Complex Interest Servers 7,19 generate a LISP notification and enter it into JESS' working memory. The Complex Interest Servers 7,19 enter only those notifications that are generated from simple interests that constitute a complex interest into JESS. The Complex Interest Servers 7,19 dispatch all others to clients, as they are not part of any complex interest. A JESS LISP notification is very similar to a notification received by the Complex Interest Servers 7,19 and is a named data structure with attribute-value pairs. The name of the data structure functions as a class name, in that all data structures with this name possess the same set of named attributes. By carefully choosing a naming scheme, a one-to-one mapping is generated of all registered event type names in all domains in the Event Template Repository server 5 of FIG. 4A to JESS notifications. The names of LISP notifications are constructed by appending the value of the attribute type_name to the value of the attribute domain_name of the reported notification. Thus, a notification with type_name “deleteFolder” and domain_name “DOC” results in the generation of a DOCDeleteFolder JESS notification. This JESS notification possesses all the attributes of the “deleteFolder” event type in application class “DOC”. In addition, the attribute subscriptionID is added, which is the subscription ID of the simple interest to which the reported event matched. The subscriptionID attribute is added to guarantee that the Complex Interest Servers 7,19 evaluate only those notifications that actually match the constituent simple interest against the constraints of the parent complex interest.

The Complex Interest Servers 7,19 construct a LISP rule in the expert system for each declared complex interest. The patterns in the if portion of the constructed rule are designed to match the JESS notifications generated from the simple interest notifications that the Complex Interest Servers 7,19 receive. The client-specified constraints between these notifications act as constraints between the patterns in the rule. The then portion of the rule describes how the service will notify the interested party when the rule becomes active.

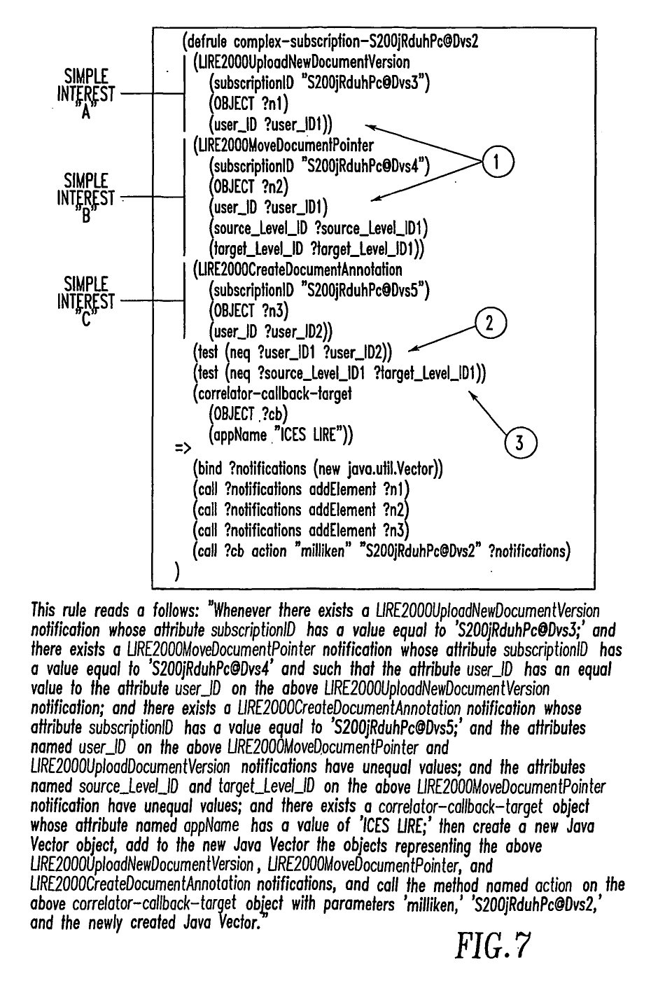

FIG. 7 shows the exemplary rule that the Complex Interest Servers 7,19 generate in response to the declaration of complex interest, shown above, as well as its clear-text explanation.

JESS' inference engine preferably implements the Rete Algorithm, an efficient algorithm for matching patterns to rules. See Forgy, C. L., Rete: A Fast Algorithm for the Many Pattern/1any Object Pattern Matching Problem, Artificial Intelligence, vol. 19(1), pp. 17-37 (1982). The Rete Algorithm drastically improves the speed of expert systems, particularly those with large rule and/or fact bases, by limiting the effort required to recompute the active set after a rule is fired. It takes advantage of two empirical observations: (1) Temporal Redundancy—the firing of a rule usually changes only a few facts and, usually, only a few rules are affected by each of those changes; and (2) Structural Similarity—the same pattern often appears in the left-hand side of more than one rule.

The Rete Algorithm operates by efficiently “remembering” which facts in memory match which portions of which rules. In doing so, the algorithm avoids reevaluating every fact against every rule when the fact list or rule base changes only slightly. As facts are added to working memory, the algorithm only evaluates the new fact against those rules that the new fact may match. Similar efficient evaluation occurs when facts are removed from working memory or when rules are added or removed from the rule base. The algorithm accomplishes this efficiency by creating a data structure that models the rule base and its relation with facts currently in working memory. The algorithm keeps track of partial matches of rules with this data structure, thereby maintaining it. New facts that enter working memory are routed efficiently only to those patterns (in the data structure, and hence the rule base) with which they may match.

The algorithm efficiently routes facts to patterns with which they may match by exploiting information given to the expert system a priori about the structure of the facts that may enter working memory. Specifically, each notification fact that enters working memory must adhere to a named template that names and types each of the attributes of the fact. Registration data is employed for each domain's type names to generate the templates for JESS notifications entering working memory. Each event type name in every domain has a unique template name as described above. Being written in Java, JESS employs templates in the form of Java Beans. “Beans” is the component architecture for Java that enables developers to create reusable software components that can then be assembled to create applications without writing any code. Any Java object is actually a Bean. A Java object's class members are mapped to Bean properties by the object implementer by either following a simple member naming scheme or explicitly providing a BeanInfo object along with the object implementation. The Complex Interest Servers 7,19 automatically create the Beans from event type name data when instructed to do so by an administrator. Beans are generated after some entity enters or changes event type data via registration.

The correlation of notifications to provide the complex interest service covers constraints for those attributes present on those event type names pre-registered in the Event Template Repository server 5 of FIG. 4A. Templates of JESS notifications facts are constructed that enter JESS working memory when those events are reported to the Complex Interest Servers 7,19.

In accordance with the present invention, scaling of the Complex Interest Server application, as provided by the Complex Interest Server 7 of FIG. 4A or the Complex Interest Server 19 of FIG. 4B, is provided if that service fails to provide a suitable level of service (e.g., because of increased user (client) demand or increased user load).

As employed herein, a server instance means, for example, one of plural servers (e.g., of a server farm) or another segment or partition (e.g., memory, disk storage, and/or processor) of a single server platform.

As discussed below in connection with Examples 1-3, scaling is provided, for example, by starting another server instance of the CIS, in order to provide additional capacity. The spawning complex notification service (e.g., the Complex Interest Server 19 of FIG. 4B) then transfers some of the complex event filters (not shown) and the corresponding portion of the partially matched complex event filter state (not shown) to the newly spawned server instance (not shown in FIG. 4B). Finally, the spawning application directs the one or more clients, such as client 14, to whom the partially matched complex event filter state belongs, to use the newly spawned server instance. The spawning server instance performs this distribution to the spawned server instance, in order to distribute more evenly the load between the two server instances. In general, a server instance of the complex notification service may transfer clients to other running server instance(s) (e.g., in an attempt to improve performance of the notification service measurement system 11 as a whole) if the other server instance is more lightly loaded and agrees to accept the new clients.

Each of the complex notification service applications uses the same running instance of the OMG Notification Server 12 to provide its own service. First, as load increases further, another instance, such as 12A or 12B, of the original OMG Notification Server 12 of FIG. 4B may be started. Second, the applications that use that Service (i.e., client applications 13,14 and complex notification service applications, such as the Complex Interest Server 19) are distributed among the running OMG Notification Service instances, such as 12,12A,12B.

Each of these two scaling actions (i.e., scaling of the complex notification service; and scaling of the OMG Notification Server 12) are independent of the other. In other words, either one or both of those scaling actions may be employed. This structure provides simple and complex notification services at an acceptable rate of feedthrough in a wide range of applications.

In the face of poor service, there is the need to determine whether the OMG Notification Service(s) 12 (and/or 12A,12B) or the complex notification service application(s) of the Complex Interest Server(s) 19 are failing to provide a suitable quality of service. To address this problem, each component of the simple and complex notification service is independently measured to ascertain relative changes in performance. If, for example, in response to increased user demand and/or load, there are increases in feedback time from the CIS 19 with no corresponding increases in feedback time from the OMG Notification Server 12, then it is inferred that the complex notification service is not providing a suitable quality of service. Alternatively, if, for example, there are increases in feedback time from both the complex notification service and the OMG Notification Server 12, then it is inferred that it is at least the OMG Notification Server 12 that is not providing a suitable quality of service. In either case, another instance of the service that is not providing a suitable quality of service is started, and the clients thereof are suitably distributed as discussed above. Although believed to be an infrequent occurrence, if there are increases in feedback time from only the OMG Notification Server 12 (e.g., arising from a relatively large number of simple interest registrations and/or notifications 15,16), then it is inferred that the OMG Notification Server 12 is not providing a suitable quality of service.

There may be advantages and disadvantages in splitting the routing of simple interests and complex interests. The following three examples show scaling for complex interests as provided by the complex notification service of the Complex Interest Server 19.

### EXAMPLE 1

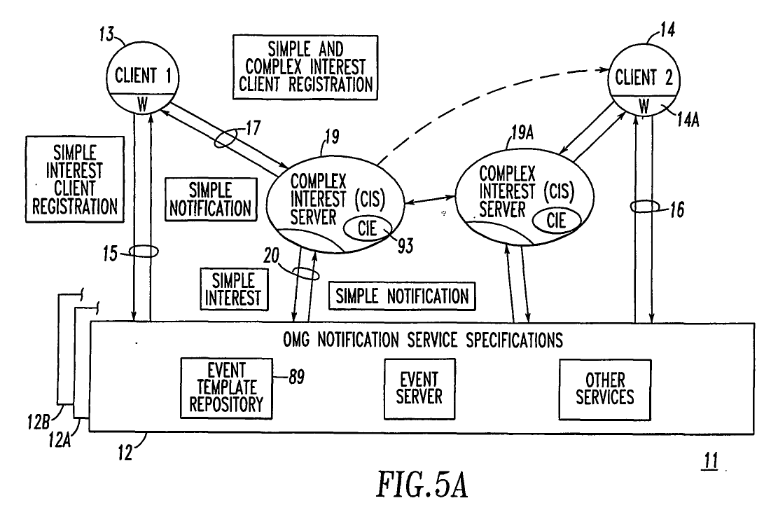

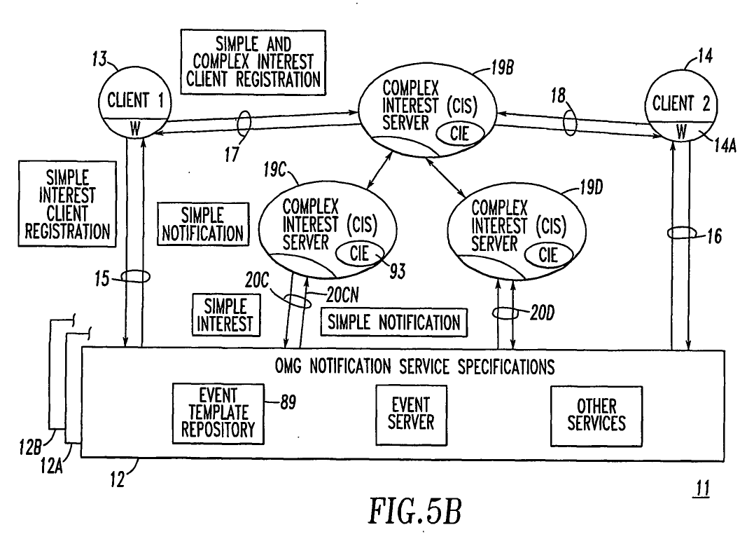

In this example, as shown in the FIG. 5A, the Complex Interest Server 19 notices an increased load based upon suitable feedback measures on its complex interest matching computations. In response, the Complex Interest Server 19 spawns another complex notification service as provided by Complex Interest Server 19A. Upon invoking this spawned service, the original Complex Interest Server 19 transfers the complex interests of one or more clients, such as client 14. For example, for each of those transferred client(s), the Complex Interest Server 19 transfers the current state of the complex interests (not shown) and the declarations of the complex interests (not shown) for that client being transferred to the spawned service of Complex Interest Server 19A. The Complex Interest Server 19 also ensures that the transferred client 14 is made aware of the new Complex Interest Server instance 19A before control is transferred.

### EXAMPLE 2

As shown in FIG. 5B, all of the clients 13,14 operate through a control Complex Interest Server 19B that acts as a load distributor. Initially, there is the single (control) Complex Interest Server 19B. As soon as the control Complex Interest Server 19B detects increased load based upon suitable feedback measures on the complex interest matching computations, that server 19B creates two Complex Interest Server instances 19C,19D and, then, transfers the complex interests set and the current state of the complex interests of each of the clients 13,14 to the respective server instances 19C,19D. The control Complex Interest Server 19B also establishes connections 20C,20D between those respective server instances 19C,19D and the existing OMG Notification Server 12 (e.g., the Elvin server 6 of FIG. 4A, the Event Server 91 of FIG. 4B). Once this transfer is completed, the control Complex Interest Server 19B passes through the complex interest notification (e.g., 20CN) from the appropriate server instance 19C to the corresponding client (e.g., client 13). In this example, the clients 13,14 do not directly perceive of any change in the load balancing, since each client communicates with the same control Complex Interest Server instance 19B.

Subsequently, either one or both of the two new Complex Interest Server instances 19C,19D may detect increased load based upon suitable feedback measures on the complex interest matching computations. That server instance (e.g., 19C) informs the control Complex Interest Server 19B, which creates another Complex Interest Server instance (not shown), and, then, transfers the complex interests set and the current state of the complex interests of each of the corresponding clients to the new server instance from the previous server instance (e.g., 19C).

### EXAMPLE 3

As an alternative to FIG. 5A (Example 1), the Complex Interest Server 19, in response to increased load, spawns two other Complex Interest Server instances (not shown), each of which provide the complex notification services. Upon invoking these spawned server instances, the original Complex Interest Server 19 transfers the complex interests of the various clients 13,14. For example, for each of those transferred clients 13,14, the original Complex Interest Server 19 transfers the current state of the complex interests and the declarations of the complex interests for that transferred client to the corresponding one of the spawned server instances. The original Complex Interest Server 19 also ensures that the transferred client is made aware of the corresponding new Complex Interest Server instance before control is transferred. In this manner, the two new Complex Interest Server instances balance the load, and the original Complex Interest Server 19 terminates.

The present invention assesses whether a notification service is performing well by determining if users can see the effects of each other's actions in a timely manner. Otherwise, the notification service is not performing well. A feedback measure, in contrast to the prior feedthrough measure, is preferably employed as a better and more accurate measure of system performance of the Complex Interest Servers 7,19 and/or the OMG Notification Server 12. The feedback measure and the system to measure feedback provide a better and more accurate mechanism to make scaling decisions in order to maintain a consistent level of performance with increased loading on the various notification servers. Hence, more precise numerical values may be assigned to the performance of a notification system, in a test environment and/or in service under user load, in order to remove uncertainty in measured scalability during actual performance.

If feedthrough is the ability to see the effects of another's actions, then the observer should take the elapsed time between the occurrence of an interesting action or event and the notice of its occurrence by an interested party as a measure of feedthrough.

It may be difficult, however, to determine exactly when an event occurs and when an interested party notices its occurrence. For example, there may be a delay on the client's part in recognizing that an event has occurred (e.g., if the event is not directly due to a user's action) before it actually reports the event. There may be a similar delay in recognizing that another entity has performed some interesting action, even though the interested party may have the capacity for instantaneous recognition.

These uncertainties are further accentuated by the lack of a global clock. In this regard, if the event generator and the interested party employ different computers and/or different communication networks, then it may be impossible to determine the elapsed time even if the local event occurrence time and the event notice time are exactly known.

At one end of the feedthrough spectrum, a user sees the actions of other users instantaneously. This corresponds to an interested party receiving a callback from the notification service simultaneously with the report of an event of interest, with an elapsed time of zero. This is clearly impossible, since it takes some non-zero amount of time for a message to travel from the event-generating client to the notification service, another time for the notification service to process the event, and another time for the message to travel back to the interested client. Due to the lack of a global clock, however, it might appear that a client receives a callback “before” the occurrence of the event from which it is generated if the computer clock of the interested party is “behind” the computer clock of the event generator.

At the other end of the feedthrough spectrum, a user never sees the effects of other users' actions. This corresponds to an interested party not receiving a callback from the notification service when an event of interest occurs, even after an infinite amount of time.

As shown in FIG. 8, the elapsed time T (i. e., t₂−t₁) is preferably measured between a report by a client 21 of an event at time t₁ and receipt by an interested party 22 of a callback at time t₂. The choice of the event report time rather than the event occurrence time removes from consideration the uncertainty of when the event actually occurred along with the delay between the event occurrence time and the event report time. Similarly, the time that the interested party 22 receives a callback is employed rather than the time of recognition of an interesting event, Since the preferred method and apparatus measure time between interactions with the notification server or service 24, these choices provide a true measure of the notification service's performance.

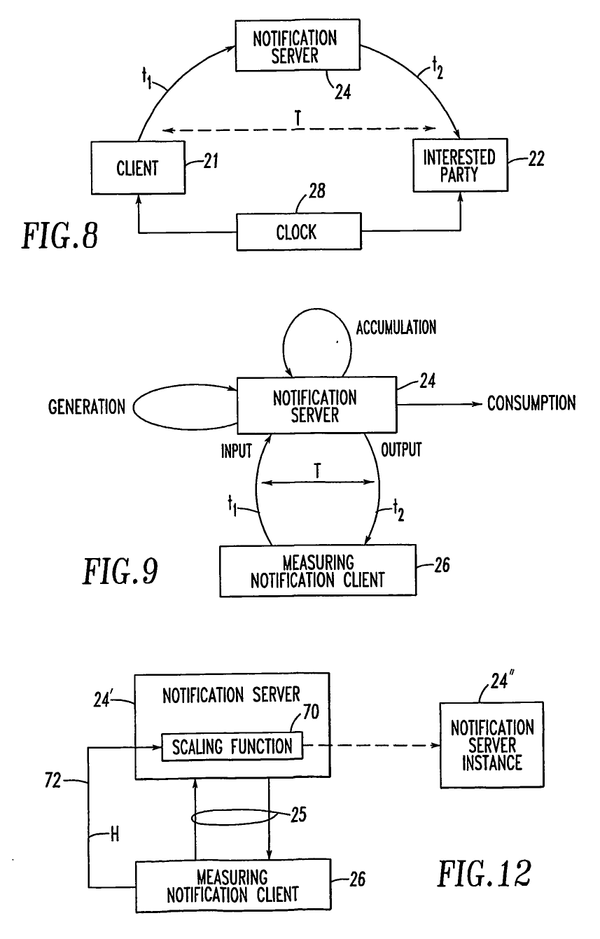

As shown in FIG. 9, the elapsed time T from a client's reporting an event at t₁ to the receipt of the callback due to that event at t₂ is preferably measured at the same client 26, in order to eliminate the lack of a global clock from uncertainty in the measurements. In this regard, by measuring the elapsed time from the report of the event to the receipt of the callback on the same client 26, feedback rather than feedthrough is actually measured. However, in this context, feedback and feedthrough only differ in the ultimate destination of the event. In all other aspects of event routing and transport, they are equivalent. By measuring feedback rather than feedthrough, this places a lower bound on the elapsed time T, since it is impossible for any other entities (i.e., other than the event performer or the event reporter) to more quickly know about the occurrence of the event. It will be appreciated that this example is equivalent to the example of FIG. 8 in which the client 21 and the interested party 22 have a common system clock 28, or in which separate clocks (not shown) of such client and interested party are matched with suitable precision.

There are four important aspects to event feedthrough: (1) event report rate; (2) event callback rate; (3) the correspondence between the event report rate and the event callback rate; and (4) the event holdup in the notification service 24. The event report rate is preferably measured by providing a “measuring” notification client 26, which measures the difference in times between: (a) an event that the notification client 26 reports; and (b) the generation of a corresponding callback from the notification service 24.

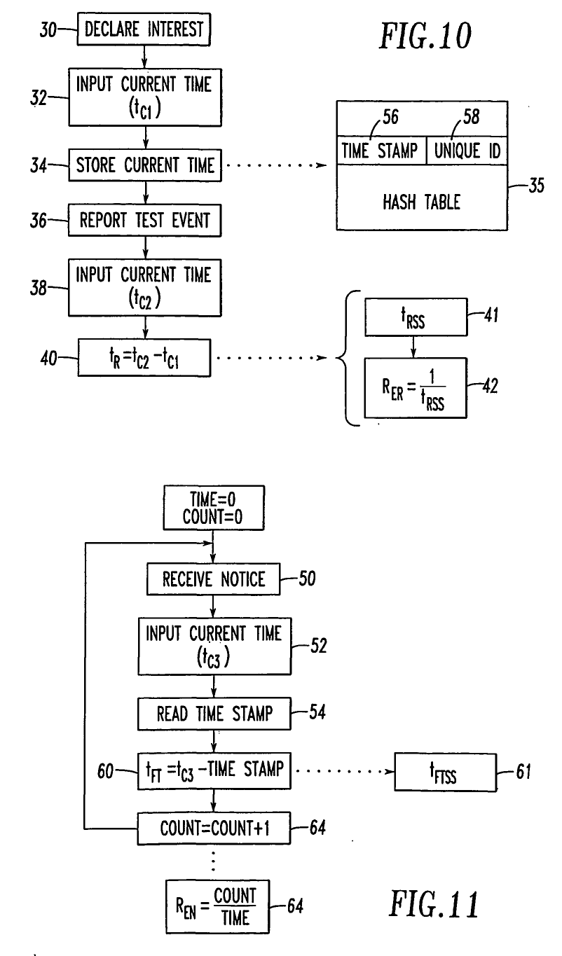

FIG. 10 shows a preferred procedure followed by an observer in measuring feedback and reporting salient data about the performance of a notification service, such as 24 of FIG. 9. First, at 30, the notification client 26 declares an interest in receiving a notification when it reports a test event with known parameters to the notification service 24. Next, at 32, the notification client 26 inputs the current time t_{C1} and, at 34, stores the current time t_{C1} in a hash table 35 keyed by a unique ID. Immediately thereafter, at 36, the notification client 26 reports a test event with that unique ID to the notification service 24, with the test event matching the previously declared interest. Again, at 38, the notification client 26 inputs the current time t_{C2}. Next, at 40, the time t_{R} required to report the event to the notification service 24 is determined by subtracting the time t_{C1} at step 32 from the time t_{C2} at step 38. This measurement includes the overhead time that the client 26 employs to construct a remote procedure call, the time for the notification service 24 to execute the call, and the overhead time for the client 26 to receive the results from the call. This procedure of recording time stamps before and after reporting an event is repeated for a suitable time, in order to gather steady-state values of the difference at step 40. In turn, the observer calculates, at 42, the event report rate R_{ER}=1/t_{RSS} by inverting the steady-state elapsed time t_{RSS} 41 needed to report one event.

In response to each of the test events which the measuring notification client 26 reports, at 36, the notification service 24 checks those test events against all active interests as it receives them from that client. As indicated above, the notification service 24 notifies the measuring notification client 26 for each event received that matches the declared interest.

Referring to FIG. 11, as soon as the measuring notification client 26 receives a notice, at 50, it inputs the current time t_{C3}, at 52, and reads, at 54, the time stamp 56 it stored, at 34 of FIG. 10, when it reported, at 36, that event (i.e., as identified by its unique ID 58) to the notification service 24. Then, at 60, the measuring notification client 26 determines the feedthrough t_{FT} by subtracting the stored time stamp 56 from the current time t_{C3} at 52 (i.e., the elapsed time since the report of the event). Again, this measured/calculated time includes some overhead of the client 26 constructing and executing the event report remote procedure call, as well as receiving the callback from the notification service 24. At 62, the count of notices received is incremented, after which the process is repeated at 50. The observer measures, at 64, the event notification rate R_{EN}=COUNT/TIME by dividing the COUNT of notices received at step 62 from the notification service 24 by the time interval TIME in which those events were generated (e.g., the time since step 50 was first executed).

Equation 1 shows a general balance equation on events about the notification service 24 of FIG. 9:

Input+Generation=Output+Accumulation+Consumption Eq. (1)

If the notification service 24 does not generate events on its own or consume any events reported to it, then the Generation and Consumption terms are both equal to zero. In turn, the resulting balance equation is shown in Equation 2:

Input=Output+Accumulation Eq. (2)

In order to guarantee that the notification service 24 delivers all events that the measuring notification client 26 reports to it, the average value of the Accumulation term must be zero. Thus, the event report rate (i.e., the Input term, R_{ER}) must be equal to the event callback or notification rate (i.e., the Output Term, R_{EN}).

The equality of the event report rate R_{ER} and the event notification rate R_{EN} implies that the holdup of events at the notification service 24 is time-invariant at a fixed event report rate. In accordance with the invention, the holdup H is calculated by comparing the steady state event report response time t_{RSS} 41 to the steady state callback receipt response time t_{FTSS} 61. For example, a measuring notification client, such as 26, may have an exemplary event report rate R_{ER} for reporting events to the notification service 24 of 7.12 Hz, or one event every 140 ms. In turn, the same measuring notification client 26 may receive, for example, the callback notification 288 ms after it reports that event. In the meantime, the measuring notification client 26 is able to report two events (ie., in this example, taking two 140 ms periods or 280 ms total) and is very early (ie., 8 ms=288 ms−280 ms) in the process of reporting a third event before it receives the callback notification for the first event. In this example, the holdup of events at the notification service 24 is, therefore, about two events. Preferably, in order to maintain a zero average value of the Accumulation term, the steady state callback receipt response time t_{FTSS} should be less than or equal to the steady state event report response time t_{RSS}.

FIG. 12 shows another notification server 24′ and the measuring notification client 26 of FIG. 9, which are interconnected by a suitable communication network 25. The notification server 24′ is similar to the notification server 24 of FIG. 9, except that it includes a scaling function 70, which inputs the holdup measure H 72 from measuring notification client 26. As one example, the scaling function 70 determines if the holdup measure H 72 is above a suitable threshold value (i.e., the steady state callback receipt response time t_{FTSS} is greater than the steady state event report response time t_{RSS} plus the threshold value), (e.g., preferably ≧0 and more preferably >0) and if so, then another notification server 24″ instance is started.

Although a notification server 24′ and a separate (e.g., interconnected by a LAN or WAN) measuring notification client 26 have been disclosed, the invention is applicable to one or more server platforms, which include a notification server process and a separate measuring notification client process in the same or related platforms. In this example, the corresponding event notification rate would be somewhat greater than the rate R_{EN} of FIG. 11 (e.g., due to reduced communication time between the notification server and measuring notification client processes).

Although scaling of a simple and/or complex notification service 24′ by employing the exemplary holdup H measure has been disclosed, other measures for scaling the exemplary Complex Interest Servers 7,19 include: (1) measuring a steady state time between receiving an event at the Complex Interest Server and reporting the callback to the client from the Complex Interest Server; (2) measuring the rate of servicing of events and reporting callbacks to clients from the Complex Interest Server with increases in the rate of receiving events at the Complex Interest Server (i.e., a constant or decreasing rate of servicing of events and reporting callbacks to clients from the Complex Interest Server with increases in the rate of receiving events at the Complex Interest Server corresponds to increased scaling of instances of the Complex Interest Servers and/or OMG Notification Server 12 servers); and/or (3) monitoring the size of the working memory of OMG Notification Service servers 12 (i.e., larger values of working memory size primarily correspond to increased values of the holdup H measure, which is addressed by instantiating new instances of the Complex Interest Servers and/or OMG Notification Service servers). In summary, a wide range of measures may be employed to scale one or both of the simple and complex notification services, and/or to scale a notification service for both simple and complex interests, such as the Complex Interest Server 19.

A new feedback measure and an apparatus to measure feedback for notification server systems are disclosed herein. The exemplary feedback measure is superior to known prior measures and is advantageously employed in handling the scalability of the notification servers 7,12,19,24,24′. Hence, the feedback measure is employed for both monitoring performance and, also, making scaling decisions.

FIG. 14 shows a procedure 200 including a scaling decision function, which spawns a new Complex Interest Server (CIS) 201 in light of the measurement of the holdup measure H 72, which is supplied by the measuring notification client 26 of FIGS. 9 and 12. The procedure 200 may be employed for the configuration of scaling in Example 1, FIG. 5A. Similar procedures may be employed with suitable variations to provide the configuration of scaling for Example 2, FIG. 5B and Example 3. The newly spawned server of the exemplary procedure may employ the OMG Notification Server 12 or one or more OMG Notification Servers, federated or otherwise.

The essential elements of scaling include deciding when to scale up, and how to partition the system state in order to maximize performance gain when this operation is performed. The measuring notification client 26 identifies performance inadequacies. In turn, the system state is partitioned when the measuring notification client 26 identifies these inadequacies. The function that decides how to partition the system state is described, below.

The state of a Complex Interest Server, at any given time instance, is defined by: (1) the set of active complex interests (e.g., in the exemplary embodiment, being represented as rules in the expert system shell); (2) events reported to the CIS from the OMG server (matching rules); and (3) the set of active simple interests (as declared on the simple interest server).

There are two cases to consider when spawning a new Complex Interest Server: (1) fully replicate the set of complex interests in a new Complex Interest Server; and (2) replicate a subset of complex interests in a new Complex Interest Server. The first case is believed to be infeasible, since one would have to maintain a fully-replicated state going forward (since complex interests are reported to both old and new servers, one would have to send complex interest declarations and cancellations continually between Complex Interest Servers—this takes O(nⁿ) time and would defeat the purpose of spawning a new CIS server in the first place).

The preferred approach employs the partitioning of complex interests (and, therefore, clients, which is relatively easy because the CIS client list may readily be controlled to redirect clients to another CIS server without the actual client even knowing about it) between the old and the new servers, using various internal metrics. For example, the preferred metrics employ measurements (e.g., internal details of the CIS server) that a “measuring client,” such as the measuring notification client 26, cannot provide.

Two examples of the measurements include: (1) the number of events partially matched per complex interest; and (2) the cumulative number of sets of events detected per complex interest.

For these examples, if the server instance (e.g., computer; processor) hosting the Complex Interest Server is memory bound, then the complex interests are partitioned between the old and the new Complex Interest Servers such that the amount of memory (i.e., working memory) employed for partially matched complex interests is distributed by some predetermined proportion (e.g., without limitation, about equal) in each server. Also, if the server instance hosting the Complex Interest Server is processor bound, then the complex interests are partitioned between the old and the new Complex Interest Servers such that the (potential) number of events reported to each server is in some predetermined proportion (e.g., without limitation, about equal) (e.g., based on past performance). On the other hand, if the server instance hosting the Complex Interest Server is neither processor bound nor memory bound, then the complex interests are partitioned between the old and the new Complex Interest Servers arbitrarily such that some predetermined proportion (e.g., without limitation, about equal) of interests are assigned to each. Otherwise, if the server instance hosting the Complex Interest Server is both processor bound and memory bound, then the complex interests are partitioned between the old and the new Complex Interest Servers arbitrarily by choosing one of the first two methods above (i.e., treating the Complex Interest Server as if it is either processor bound or memory bound). The foregoing constitutes a decision function that handles partitioning complex interests between two Complex Interest Servers.

In this example, other resources, such as disk space and network throughput, are ignored, since available memory and processor cycles are believed to be limiting “reagents”.

The procedure 200 starts, at 202, by the CIS receiving the holdup measure H 72 of FIG. 12, from a measuring notification client, such as 26. At 203, if the holdup measure H 72 is not greater than a suitable threshold, then step 202 is repeated. On the other hand, if the holdup measure H 72 is greater than the threshold, then this indicates inadequate performance of the CIS and execution resumes at step 204. As an alternative to steps 202 and 203, the CIS may receive notification from the measuring notification client, such as 26, of a violation of a threshold by the holdup measure H 72 of FIG. 12.

Next, at 204, internal measurements are performed to determine if this CIS is memory or processor bound. At 205, if the internal measurements of step 204 show that this CIS is neither memory nor processor bound, then the current violation of the threshold from step 203 is ignored, a report of the same is provided to the measuring notification client 26, and execution resumes at step 202.

On the other hand, if the check of the internal measurements at 205 shows that the CIS is memory or processor bound, then, at 206, the measuring notification client 26 is informed that spawning of the new CIS 201 will occur immediately. Next, at 208, the partitioning of the complex interests is determined based on the internal measurements of step 204.

For example, the clients, which use the present CIS, are ordered based on the count of simple constituent interests, the count of partially matched complex interests, and the resource exhaustion. First, these clients are ordered by the count of constituent simple interests in the order of descending count. When two or more clients have the same count of constituent simple interests, then those clients are ordered in order of descending count of partially matched complex interests. When two or more clients have the same count of partially matched complex interests, then those clients are ordered by the client having most recently matched an incoming notification from the OMG notification server if the internal measurements of step 204 show that the CIS is processor bound, or by the client having least recently matched an incoming notification from the OMG notification server if those internal measurements show the CIS is memory bound.

At 210, the total number, N, of constituent simple interests registered with this CIS is counted and the count of constituent moved simple interests is initialized to zero. Next, at 212, the other Complex Interest Server (CIS) 201 is spawned. Preferably, another computer is employed (e.g., if the present CIS is indeed memory or processor bound, then spawning a new server instance on the same computer will afford less of a performance improvement than spawning a new server instance on a different computer). This new CIS 201 should preferably behave as a public resource, with all the rights and responsibilities granted to it. In other words, it is preferably autonomous and is in no way “controlled” by the original CIS (with the exception of the initial transfer of complex interests as described below at step 221).

At 214, the original CIS orders the clients based on the count of interests and the count of active complex interests for a client registration, with the count of interests being the first field, and the count of active complex interests being the second field for the descending sorting order. This list is further ordered by choosing the client with the active complex interests that were partially matched least recently at step 208 if the CIS is memory bound, or partially matched most recently at step 208 if the CIS is processor bound.

Next, at 215, if the ordered list of clients is empty, then execution resumes at 224. On the other hand, if the ordered list of clients is not empty, then, at 216, a client is chosen from the top of the ordered list of step 214 to move to the new CIS 201. At 217, the client chosen at 216 is removed from the top of the ordered list. Next, at 219, it is determined if the chosen client of step 216 permits removal from the original CIS. The original CIS notifies the chosen client (or the CIS client library server) that it intends to transfer their interests to the newly spawned CIS 201. The chosen client may reject the proposed move, in which case execution resumes at step 215. If, however, the chosen client permits removal, then, at 221, the original CIS moves the active complex interests for that chosen client, along with any partially matched interest, over to the new CIS 201. At this point, the new CIS 201 contacts the chosen client and informs the same that the move is complete, thereby causing the chosen client's wrapper (e.g., W 14A of FIG. 4B) to rescind the complex interests on the original CIS. The state after this transfer to the new CIS 201 and the renunciation of the complex interest on the original CIS should be indistinguishable from the state before the transfer, if no events that match the constituent simple interests have been reported to the underlying OMG notification server.

At 222, the count of moved constituent simple interests (as initialized at step 210) is updated by adding to it the count of constituent simple interests for this client. Next, at 223, if the count of the moved constituent interests is more than half of the total count, N, of constituent simple interests calculated in step 210, then execution resumes at step 224. Otherwise, if the count of the moved constituent interests is less than or equal to a predetermined proportion (e.g., without limitation, about N/2), then execution resumes at 215.

At 224, the measuring notification client 26 is informed that the new CIS 201 has been established and that the client 26 should also measure that CIS. Finally, at 226, execution resumes at step 202. This is repeated until there are no more reports of violation of the performance threshold from the measuring notification client 26 of the original CIS.

While the above procedure is employed with a Complex Interest Server, which primarily serves complex interests, the same procedure may be employed to spawn an instance of an OMG Notification Server in a similar manner. All one needs to supply is a suitable decision function that partitions simple interests among two OMG Notification Servers based on exhaustion of resources, such as processor or memory. Once this is in hand, an OMG Notification Server would be able to respond to violations in performance as measured by a measuring notification client. The details of the transfer of simple interests from an OMG Notification Server to a newly spawned instance of an OMG Notification server would vary slightly from the transfer of complex interests in the originating CIS to the newly spawned CIS due to the existence of the rule-based CIE in the Complex Interest Server.

The notification service 24 and the notification server 24′ may be simple and/or complex services and/or servers.

The present invention provides users of an OMG Notification Service with the ability to arbitrarily correlate events in ways that those users find relevant. The extensions to the OMG Notification Services disclosed herein allow clients of those Services to become aware of sets of events meeting arbitrary criteria.

The exemplary notification servers disclosed herein may be employed in association with a wide range of clients and/or applications, including, but not limited to, engineering applications; clinical events; office events; education events; any work setting dealing with information, documents and/or media; and in contexts where changes in information space are an integral part of awareness in any work domain. This architecture allows for customizing the complex rules for different business and work processes in the content of the applications used in the domain.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended hereto and any and all equivalents thereof.

What is claimed is:

1. A method of servicing complex interests for a plurality of client applications or subscribers, said method comprising:
specifying a plurality of complex interests from the client applications or the subscribers;
forming at least one of the complex interests from a plurality of constituent simple interests;
specifying a plurality of constraints over said constituent simple interests;
specifying a plurality of event filters from the client applications or the subscribers;
employing as at least one of the event filters a plurality of simple event filters, which match the constituent simple interests;
detecting a set of events, which set matches said at least one of the complex interests;
notifying one of the client applications or the subscribers when said set of events is detected;
employing at least one server to detect said set of events and to notify said one of said client applications or the subscribers when said set of events is detected; and
scaling said at least one server.

2. The method of claim 1 further comprising
mimicking a simple notification service to notify one of the client applications of an event passing through one of the event filters.

3. The method of claim 1 further comprising
employing application wrappers to communicate with said client applications.

4. The method of claim 1 further comprising
employing a plurality of servers as said at least one server.

5. The method of claim 4 further comprising
employing a plurality of complex interest servers and at least one simple interest server as said at least one server.

6. The method of claim 5 further comprising
adding or removing said complex interest servers as a function of performance of said complex interest servers and said at least one simple interest server.

7. A scalable simple and complex interests notification system for a plurality of client applications or subscribers, said system comprising:
means for specifying a plurality of complex interests from the client applications or the subscribers and forming at least one of the complex interests from a plurality of constituent simple interests, with a plurality of constraints specified over the constituent simple interests;
means for receiving a plurality of event filters from the client applications or the subscribers;
means for matching the constituent simple interests from a plurality of simple event filters;
at least one server detecting a set of events, which set matches said at least one of the complex interests, and notifying one of said client applications or the subscribers when said set of events is detected; and
means for scaling said at least one server.

8. The system of claim 7 wherein said at least one server is a plurality of complex interest servers and at least one simple interest server.

9. The system of claim 7 wherein said at least one server mimics a simple notification service to notify one of the client applications of said set of events, which set matches one of the complex interests.

10. A method for providing a feedback measure for a server, said method comprising:
reporting an event from a client to said server,
determining a first time at said client associated with said reporting said event;
receiving a callback at said client or an interested party from said server responsive to said reporting said event;
determining a second time at said client or at said interested party associated with said receiving said callback; and
employing a difference between said first and second times as said feedback measure.

11. The method of claim 10 further comprising
employing a notification server as said server; and
providing said feedback measure to said notification server.

12. The method of claim 11 further comprising
employing said feedback measure to evaluate time taken to service an interest by said notification server.

13. The method of claim 11 further comprising
employing said feedback measure to evaluate when to scale said notification server.

14. The method of claim 11 further comprising
employing a complex interest server as said notification server.

15. The method of claim 11 further comprising
employing a simple interest server as said notification server.

16. The method of claim 15 further comprising
employing an OMG Notification Server as said simple interest server.

17. The method of claim 10 further comprising
employing said feedback measure to evaluate when to scale said server.

18. The method of claim 17 further comprising
employing a scaling function in said server;
inputting said feedback measure by said scaling function; and
spawning another instance of said server if said feedback measure is greater than a threshold value.

19. The method of claim 18 further comprising
employing a value greater than zero as said threshold value.

20. The method of claim 18 further comprising
employing zero as said threshold value.

21. The method of claim 10 further comprising
receiving said callback at said client from said server responsive to said reporting said event;
determining said second time at said client associated with said receiving said callback; and
determining said difference between said first and second times at said client.

22. The method of claim 10 further comprising
receiving said callback at said interest party from said server responsive to said reporting said event;
determining said second time at said interested party associated with said receiving said callback;
employing a first clock at said client to determine said first time;
employing a second clock at said interested party to determine said second time; and
synchronizing said first and second clocks.

23. The method of claim 10 further comprising
employing said feedback measure to monitor performance of said server.

24. A measuring notification client apparatus for providing a feedback measure for a notification server, said measuring notification client apparatus comprising:
means for reporting an event at a first time to said server;
means for determining the first time associated with said event;
means for receiving a callback at a second time from said server responsive to said event;
means for determining the second time associated with said callback; and
means for determining a difference between said first and second times as said feedback measure.

25. The measuring notification client apparatus of claim 24 wherein said means for determining a difference includes means for reporting said feedback measure to said server.

26. A method for scaling a notification server, said method comprising:
employing a first notification server as said notification server;
servicing a plurality of client applications and a plurality of interests at said first notification server;
receiving a feedback measure associated with said first notification server;
determining if said feedback measure is greater than a threshold value and responsively spawning a second notification server; and
transferring some of said client applications and some of said interests from the first notification server to the second notification server.

27. The method of claim 26 further comprising
employing a first complex interest server as said first notification server; and
employing a second complex interest server as said second notification server.

28. The method of claim 27 further comprising
spawning the second complex interest server from the first complex interest server.

29. The method of claim 26 further comprising
employing a first simple interest server as said first notification server; and
employing a second simple interest server as said second notification server.

30. The method of claim 29 further comprising
spawning the second simple interest server from the first simple interest server.

31. The method of claim 26 further comprising
measuring performance of said first notification server; and
transferring said some of said client applications and said some of said interests from the first notification server to the second notification server until said first notification server has transferred a predetermined proportion of said client applications and said interests based on said performance.

32. The method of claim 26 further comprising
spawning said second notification server from a third notification server.

33. The method of claim 26 further comprising
employing a first simple and complex interest server as said first notification server; and
employing a second simple and complex interest server as said second notification server.

34. The method of claim 33 further comprising
employing at least one complex interest formed from a plurality of constituent simple interests for each of the client applications;
counting the simple constituent interests for each of the client applications at said first notification server; and
ordering said client applications based upon descending count of said simple constituent interests for each of the client applications.

35. The method of claim 34 further comprising
counting partially matched complex interests for each of the client applications at said first-notification server; and
ordering said client applications based upon descending count of said partially matched complex interests for each of the client applications having identical counts of said simple constituent interests.

36. The method of claim 35 further comprising
employing a simple interest server and a complex interest server as said first notification server;
determining if said complex interest server is processor bound or memory bound; and
for each of the client applications having identical counts of said simple constituent interests and identical counts of said partially matched complex interests, ordering said client applications based upon said client applications having most recently matched an incoming notification from said simple interest server if said complex interest server is processor bound and, alternatively, ordering said client applications based upon said client applications having least recently matched an incoming notification from said simple interest server if said complex interest server is memory bound.

37. The method of claim 36 further comprising
employing a first simple interest server and a first complex interest server as said first notification server;
counting a total number of the constituent simple interests registered with the first complex interest server;
employing a second simple interest server and a second complex interest server as said second notification server; and
spawning the second complex interest server.

38. The method of claim 37 further comprising
employing a first computer as said first complex interest server and a second different computer as said second complex interest server.

39. The method of claim 37 further comprising
ordering said client applications in a list;
initializing a count of constituent moved simple interests to zero; and
choosing one of said client applications from said list to move from said first complex interest server to said second complex interest server until said list is empty or until said count of constituent moved simple interests is greater than a predetermined proportion of said total number of the constituent simple interests registered with the first complex interest server.

40. The method of claim 26 further comprising
spawning said second notification server and a third notification server from said first notification server;
transferring a first set of said client applications and said interests from the first notification server to the second notification server;
transferring a second different set of said client applications and said interests from the first notification server to the third notification server; and
terminating said first notification server.

41. The method of claim 31 comprising
employing about one half as said predetermined proportion.

42. The method of claim 39 comprising
employing about one half as said predetermined proportion.
